(19) United States
(12) Patent Application Publication
(10) Pub. No.: US 2003/0098112 A1
(43) Pub. Date: May 29, 2003

(54) Method for embedding fastener to seat cushion

(76) Inventors: Byung-Soon Jang, Namyangju-shi (KR); Han-Bong Jung, Seoul (KR)

Correspondence Address: Richard C. Woodbridge, Esq., Woodbridge & Associates, P.C., P.O. Box 592, Princeton, NJ, 08542-0592, US

(21) Appl. No.: 09/994,156

(22) Filed: Nov. 26, 2001

(51) Int. Cl. B32B 5/20

(52) U.S. Cl. 156/78; 156/93

(57) ABSTRACT

A method for embedding a fastener in a seat cushion which is adapted to recycle a fastening piece attached to a metal mold and facilitate detachment of a fastening piece embedded in a seat cushion is disclosed. The method comprises the steps of: fitting a metal support into an elongated groove formed at a metal mold; bonding either a hook piece or a loop piece of a hook-and-loop fastener to an upper surface of the metal support via heat resistant adhesive; attaching a first mating fastening piece to the fastening piece bonded to the metal support; heating the metal mold followed by injecting foaming material consisting of resin composition, foaming agent, lubricant and stabilizer into the metal mold to form a seat cushion; removing the seat cushion from the seat cushion such that fastening piece embedded in to the seat cushion is detached from the mating fastening piece bonded to the metal mold; and attaching a second fastening piece mating with the first fastening piece embedded in the seat cushion to an inner surface of a seat cover by sewing such that the first fastening piece coincides with the second fastening piece.

### BACKGROUND OF THE INVENTION

1. Field of the Invention

The present invention relates to a method for embedding a fastener in a seat cushion, and, more particularly, to a method for embedding a fastener in a seat cushion which is intended to embed a fastener in a foamed product such as a seat cushion by a molding process.

2. Description of the Prior Art

Nowadays, hook-and-loop fasteners, such as a “Velcro™” fastener, are used to attach a seat cover to a seat cushion for an automobile. Furthermore, various foamed products such as a seat have been proposed, which is integrally molded with hook-and-loop fasteners during a molding process.

In such a molding process for molding a foamed product together with hook-and-loop fasteners, a after-mentioned specific process to be described hereinafter is carried out so as to facilitate attachment of a hook-and-loop fastener to a metal mold and to prevent hook elements or loop elements of the hook-and-loop fastener from being permeated by foamed material. That is, a metal sheet is placed on either hook elements or loop elements of a hoop-and-loop fastener, and the metal sheet is coated with film coating material or soft magnetic coating material to allow a base sheet of the either elements to be fully covered with the coating material. After performing a foaming procedure, the film coating material or the soft magnetic coating material is detached from the either element of the hook-and-loop fastener and then discarded.

However, since either piece of the hook-and-loop fastener embedded in the foamed product is subjected to relatively intensive force when a film sheet formed by the film coating material or the soft magnetic coating material is detached therefrom, or when the other complementary piece of the hook-and-loop fastener which is interlocked with a seat cover is detached therefrom, the hook elements or loop elements of the fastener embedded in the foamed product is weakened or the foamed body supporting the fastener is broken down, thereby causing the piece of the fastener to be detached from the foamed product. Hence, the hook-and-loop fastener cannot be used any longer. Furthermore, since the coated film material must be discarded after the foamed product is removed from the metal mold, for the sake of attaching a hook-and-loop fastener to other foamed product, a fresh film coating material or soft magnetic coating material must be applied to the fastener, thereby increasing production cost.

### SUMMARY OF THE INVENTION

Accordingly, the present invention has been made keeping in mind the above problems occurring in the prior art, and an object of the present invention is to provide a method for embedding a fastener in a seat cushion which is adapted to replace only new fastener pieces to be embedded in a new seat cushion with new pieces during a serial production process, while causing the mating fastener pieces to remain fixedly attached to a metal mold, thereby allowing the fastening pieces embedded in the seat cushion to be easily detached from the mating fastening pieces on the metal mold and enabling the mating fastening pieces attached to the metal mold to be recycled continuously.

In order to accomplish the above object, the present invention provides a method for embedding a fastener in a seat cushion, comprising the steps of: fitting a metal support into an elongated groove formed at a metal mold; bonding either a hook piece or a loop piece of a hook-and-loop fastener to an upper surface of the metal support via a heat resistant adhesive; attaching a first mating fastening piece to the fastening piece bonded to the metal support; heating the metal mold followed by injecting foaming material consisting of resin composition, foaming agent, lubricant and stabilizer into the metal mold to form a seat cushion; removing the seat cushion from the seat cushion such that fastening piece embedded in the seat cushion is detached from the mating fastening piece bonded to the metal mold; and attaching a second fastening piece mating with the first fastening piece embedded in the seat cushion to an inner surface of a seat cover by sewing such that the first fastening piece coincides with the second fastening piece.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view showing a hook-and-loop fastener attached to a metal mold according to the present invention;

FIG. 2 is an exploded perspective view showing a hook-and-loop fastener attached to a metal mold according to another embodiment of the present invention; and

FIG. 3 is a perspective view showing a seat cushion to which a fastener is embedded according to the present invention.

### DETAILED DESCRIPTION OF THE INVENTION

Reference now should be made to the drawings, in which the same reference numerals are used throughout the different drawings to designate the same or similar components.

A process for embedding a fastener in a seat cushion according to the present will now be described as follows.

Either a hook-piece or a loop-piece, both of which together constitute a complete Velcro fastener, is fixedly fitted to a metal mold at predetermined position such that hook elements or loop elements of the fastener piece are exposed. A fastening sheet, which is provided at its side with hook or loop elements mating with elements of the fastener piece fitted to the metal mold, is attached at a portion thereof to the fastener piece fitted to the metal mold with the other part of the fastening sheet being exposed to foaming material to be injected subsequently. Thereafter, the metal mold is heated to a required temperature, and foaming material is then injected in the metal mold to form a foamed product. Finally, the foamed product is removed from the metal mold, thereby achieving the foamed product having fastening elements.

The fastening sheet serves to interlock with the mating fastener piece fitted to the metal mold, and includes a flexible mesh texture sheet consisting of flexible resin such as polyolefin, vinyl chloride plastic resin, polyester, polyamide, polyurethane, etc. and a fabric sheet or a fabric strip such as knitted fabric, woven fabric, loop pile fabric or non-woven fabric consisting of polyolefin fiber, plasticized vinyl chloride plastic fiber, acrylic fiber, natural fiber, carbon fiber, glass fiber, etc. The fastening sheet has fastening hook or loop elements on at least a portion of one surface thereof. The fastening elements are integrally formed with the fastening sheet. Hence, the fastening elements, i.e. hook or loop elements formed at the fastening sheet can be more securely attached to a seat cushion by the fastening sheet interposed therebetween.

The foaming material consisting of the foamed product is prepared by admixing foaming agent, filler, lubricant, stabilizer, coloring agent, etc. to elastic polymer such as polyurethane, acrylonitrile rubber, butadiene rubber, isoprene rubber, olefin rubber, etc. or a polymeric composition of elastic polymer and non-elastic polymer.

Regions occupied by the fastening elements can be selectively shaped and sized and molded into an arrangement to accommodate design of a seat and a seat cover. Lengths of the regions of fastening elements can be adjusted in accordance with a required application.

In an embodiment of the invention, the regions of the fastening sheet have a plurality of hook element rows parallel to one another, in which the hook elements are extended outward. The hook elements mate with non-woven fabric strips of a seat cover. Therefore, the seat cover can be easily detached from the fastening sheet by pulling the strip of the seat cover.

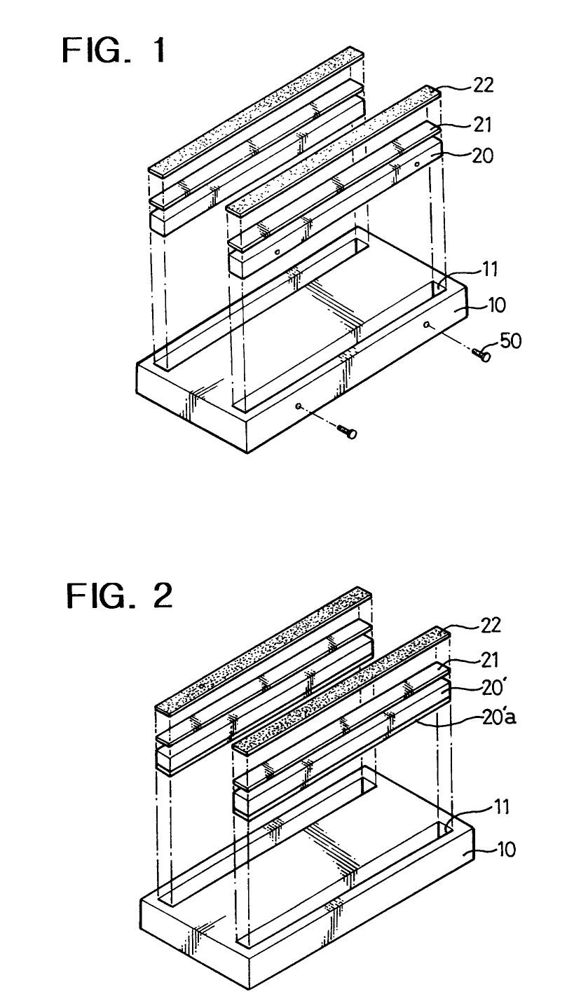

Such a method for embedding a fastener in a seat cushion according to present invention will now be briefly described with reference to FIGS. 1 to 3, which show schematically an embodiment of the present invention.

As shown in FIGS. 1 and 2, a metal mold 10 having two elongated grooves 11, which are spaced from each other by a predetermined distance, is first prepared. Metal support bars 20 are fitted into the elongated grooves 11, respectively, and then locked by locking means 50 such as screws which are threaded through the metal mold and engaged therewith.

Thereafter, either a hook-piece or a loop-piece of a hook-and-loop fastener 21 is securely bonded to an upper surface of each of the metal support bars 20 by a special heat resistant adhesive. A first fastener piece 22, which is complementary to the piece of the hook-and-loop fastener 21 bonded to the metal support bar 20 and which is to be embedded in a foamed product during foaming procedure of the product, interlocks with the stationary fastener piece 21. In the above process, such a sequence that the metal support bars 20 are fitted into the grooves 11 of the metal mold 10, the stationary fastener pieces 21 are bonded to the metal support bars 20, and the first mating fastener piece 22 interlock with the stationary fastener piece 21 may be reversed, if required.

Subsequently, melted foaming material which is prepared by mixing resin composition, lubricant, stabilization agent and the like is injected into the metal mold 10 after heating of the metal mold 10, and then foamed and shaped into a seat cushion at a temperature of 100-150□.

The first fastener pieces 22 embedded in the thus-foamed seat cushion can be easily detached from the stationary mating fasteners 21 bonded to the metal support bars 20 by applying an predetermined force to the foamed seat cushion. At this point, the stationary fastener pieces 21 remain in the metal mold 10 in state of being bonded to the metal bars 20.

Consequently, to produce a next seat cushion having fastener pieces, other first mating fastener pieces 22 interlock with the stationary fastener pieces 21 bonded to the metal support bars 20.

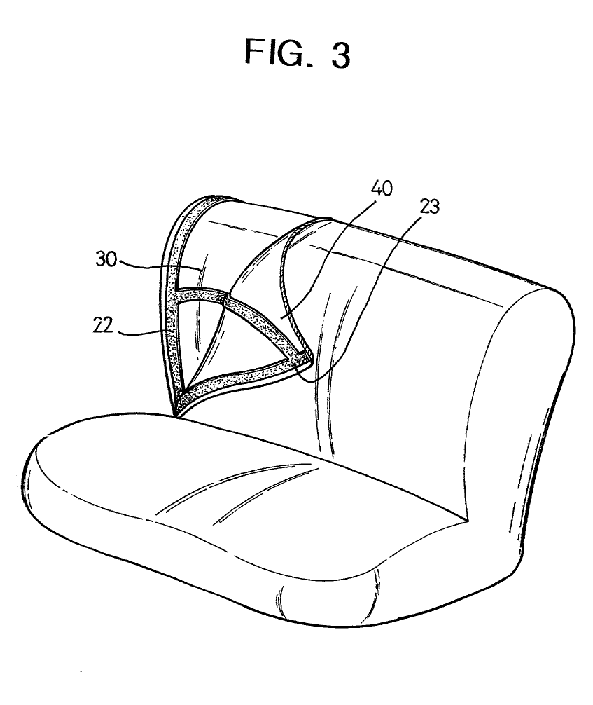

After the seat cushion is produced in the above-described way, second fastener pieces 23, which are complementary to the first fastener pieces 22, are attached to a seat cover 40 by sewing such that the second fastener pieces 23 are disposed at positions corresponding to those of the first mating fasteners 22 embedded in the seat cushion, and the seat cushion is easily and firmly covered, by the seat cover 40 without displacement of the seat cover by attaching the second fastener pieces 23 of the seat cover 40 to the first mating fastener pieces 22 of the seat cushion, as shown in FIG. 3.

FIG. 2 shows another embodiment of the present invention. As shown in the drawing, this embodiment of the invention is characterized by use of magnetic support bars 20′ in place of the metal support bars 20. In other words, the magnetic support bars 20′ are prepared into proper sizes and then inserted into the elongated grooves 11 of the metal mold 10, so that the magnetic support bars 20′ are more securely fitted to the metal mold 10 owing to magnetic attraction of the magnetic support bars 20′. As the magnetic support bar 20′, any one of a metal body, a rubber body or the like can be used as long as the body has a predetermined magnetic strength.

In this embodiment, a separate metal strip 20′a is additionally attached to a lower surface of the magnetic support bars 20′ to reduce a magnetic strength of the support arm, so that the magnetic support bar 20′ can be easily detached from the metal mold 10 owing to its diminished magnetic attraction to the metal mold, such as when the metal mold 10 is required to be repaired.

In other words, since either hook-piece or loop-piece of a hook-and-loop fastener is bonded to the support bar fitted in the metal mold and the other mating piece of the fastener is provided to the seat cushion and then integrally embedded therein, the other mating piece of the fastener embedded in the seat cushion can be prevented from being loosened and from being detached from the foamed seat cushion due to breakage of the portion of the foamed body grasping the fastener even though the other mating piece is applied with relatively intense force, such as when the foamed seat cushion is removed from the metal mold.

Although the method according to the present invention has been described in regard to two elongated grooves formed at a metal mold and the corresponding number of fastener pieces, those skilled in the art will appreciate that the grooves and fastener pieces may be formed in various shapes and numbers.

As described above, the present invention provides a method for embedding a fastener in a seat cushion which is carried out in such a way that only new fastener pieces to be embedded in a new seat cushion with are replaced with new pieces during a serial production process, while causing the mating fastener pieces to remain fixedly attached to a metal mold. Therefore, the stationary fastener pieces bonded to the support can be almost permanently used without detachment from the metal mold, and the fastener pieces embedded in a seat cushion can be easily detached from the mating fastener pieces bonded to the support components of the metal mold. Hence, it is possible to use the fastener pieces bonded to the support components, the support components and the metal mold for a long period of time, thereby reducing production cost.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method for embedding a fastener in a seat cushion, comprising the steps of:
fitting a metal support into an elongated groove formed at a metal mold;
bonding either a hook piece or a loop piece of a hook-and-loop fastener to an upper surface of the metal support via a heat resistant adhesive;
attaching a first mating fastening piece to the fastening piece bonded to the metal support;
heating the metal mold followed by injecting foaming material consisting of resin composition, foaming agent, lubricant and stabilizer into the metal mold to form a seat cushion;
removing the seat cushion from the seat cushion such that the fastening piece embedded in the seat cushion is detached from the mating fastening piece bonded to the metal mold; and
attaching a second fastening piece mating with the first fastening piece embedded in the seat cushion to an inner surface of a seat cover by sewing such that the first fastening piece coincides with the second fastening piece.

2. The method as set forth in claim 1, in which said metal support is made of a magnetic material capable of being fitted in the groove of the metal mold by attraction thereto.
